(19) United States
(12) Patent Application Publication
(10) Pub. No.: US 2026/0364391 A1
(43) Pub. Date: Nov. 19, 2026

(54) Fire Extinguishing and Irrigation Control Method, Fire Extinguishing and Irrigation Control System, and Non-transitory Storage Medium

(71) Applicant: Shanghai MXCHIP Information Technology Co., Ltd, Shanghai (CN)

(72) Inventors: Yonghong WANG, Shanghai (CN); Wei XU, Shanghai (CN); Li LIU, Shanghai (CN)

(21) Appl. No.: 19/207,234

(22) Filed: May 13, 2025

(51) Int. Cl. A62C 37/44; A01G 25/16; A62C 3/02; A62C 31/00

(52) U.S. Cl. CPC A62C 37/44; A01G 25/16; A62C 3/0271; A62C 31/005

(57) ABSTRACT

The present disclosure provides a fire extinguishing and irrigation control method, which includes that: environmental data of a target building in real time is acquired; a fire risk analysis is conducted on the environmental data to obtain an analysis result; in response to determining, based on the analysis result, that there is the fire risk in the surrounding environment of the target building, fire is extinguished in a fire-prone area of the target building; and in response to determining, based on the analysis result, that there is no fire risk in the surrounding environment of the target building, a vegetation area of the target building is irrigated according to system settings of the fire extinguishing and irrigation control system, thereby solving a technical problem of low resource utilization and poor safety in fire extinguishing and irrigation control methods in related art.

### TECHNICAL FIELD

The present disclosure relates to the field of information technology, and in particular, to a fire extinguishing and irrigation control method, fire extinguishing and irrigation control system, and a non-transitory storage medium.

### BACKGROUND OF THE INVENTION

The rapid development of smart home technology not only enhances the comfort and convenience of users'residence but also promotes a higher demand for outdoor fire safety and efficient resource management. However, existing roof intelligent fire extinguishing systems on and vegetation irrigation systems operate independently, failing to achieve deep integration of functionalities and intelligent sharing of resources. Traditional roof fire extinguishing systems mainly rely on single smoke sensors or temperature sensors for fire warning. Nevertheless, such sensors are susceptible to interference from environmental factors, leading to high false alarm rates and inability to accurately locate and extinguish fires. Meanwhile, the selection of fire extinguishing water sources lacks flexible management mechanisms, often fixedly using tap water, which is not only costly but also inefficient and environmentally unfriendly in terms of resource utilization. On the other hand, vegetation irrigation systems usually operate independently, focusing on comprehensive irrigation according to preset schedules. Such systems, however, often fail to achieve precise control over irrigation, easily resulting in waste of water resources. More importantly, in existing systems, the two major functions of fire extinguishing and irrigation have not achieved intelligent linkage. That is, in the absence of a fire, the water resources of a fire extinguishing system cannot be utilized by an irrigation system, and vice versa, thus leading to duplication of resource allocation and low utilization efficiency. Additionally, fire extinguishing and irrigation control systems in related art mostly rely on the power grid for energy supply, failing to fully utilize renewable energy sources like solar energy, which is not conducive to environmental protection and energy conservation. At the same time, there is a lack of effective wireless communication means between system components, making it difficult to achieve remote monitoring and intelligent control, thereby resulting in poor user experience.

For the problems mentioned above, no effective solution has been proposed yet.

### SUMMARY OF THE INVENTION

At least some embodiments of the present disclosure provide a fire extinguishing and irrigation control method, a fire extinguishing and irrigation control system, and a non-transitory storage medium, so as at least to solve a technical problem of low resource utilization and poor safety existing in fire extinguishing and irrigation control methods in related art.

According to a first aspect, some embodiments of the present disclosure provide a fire extinguishing and irrigation control method, where the fire extinguishing and irrigation control method is applied to a fire extinguishing and irrigation control system, and the fire extinguishing and irrigation control method includes that: environmental data of a target building in real time is acquired, where the environmental data is used for recording changes in surrounding environment of the target building; a fire risk analysis is conducted on the environmental data to obtain an analysis result, where the analysis result is used for determining whether there is a fire risk in the surrounding environment of the target building; in response to determining, based on the analysis result, that there is the fire risk in the surrounding environment of the target building, fire is extinguished in a fire-prone area of the target building; and in response to determining, based on the analysis result, that there is no fire risk in the surrounding environment of the target building, a vegetation area of the target building is irrigated according to system settings of the fire extinguishing and irrigation control system.

In some embodiments, the fire extinguishing and irrigation control system includes: an image acquisition component and a disaster situation detection sensing component, and an operation of acquiring the environmental data of the target building in real time includes the following steps. Image recognition is performed, through the image acquisition component, on the changes in the surrounding environment of the target building to obtain image data, and the changes in the surrounding environment of the target building are sensed, through the disaster situation detection sensing component, to obtain sensing data. The environmental data is determined based on the image data and the sensing data.

In some embodiments, the fire extinguishing and irrigation control system further includes: a fire extinguishing sprinkler component, and an operation of in response to determining, based on the analysis result, that there is the fire risk in the surrounding environment of the target building, extinguishing the fire in the fire-prone area of the target building includes the following steps. In response to determining, based on the analysis result, that there is the fire risk in the surrounding environment of the target building, the fire-prone area of the target building and fire extinguishing parameters of the fire extinguishing sprinkler component are determined based on a distribution location of the disaster situation detection sensing component, where the fire extinguishing parameters include: a spraying angle of the fire extinguishing sprinkler component, and a progressive spraying distance of the fire extinguishing sprinkler component. The fire extinguishing sprinkler component is controlled to extinguish the fire in the fire-prone area of the target building based on the fire extinguishing parameters.

In some embodiments, the fire extinguishing and irrigation control system further includes: a water pump, and an operation of controlling the fire extinguishing sprinkler component to extinguish the fire in the fire-prone area of the target building based on the fire extinguishing parameters includes the following steps. Target water source to be drawn by the water pump is determined. The fire extinguishing sprinkler component is controlled, based on the fire extinguishing parameters, to direct the target water source to the fire-prone area of the target building for fire extinguishing.

In some embodiments, the fire extinguishing and irrigation control system further includes: a water level detection sensing component, an operation of determining the target water source to be drawn by the water pump includes the following steps. In response to detecting, by the water level detection sensing component, that water level in a reservoir equipped for the target building has not dropped below a first threshold, water stored in the reservoir is determined as the target water source.

In some embodiments, an operation of determining the target water source to be drawn by the water pump further includes the following steps. In response to detecting, by the water level detection sensing component, that the water level in the reservoir has dropped below the first threshold and groundwater level has not dropped below a second threshold, groundwater is determined as the target water source.

In some embodiments, an operation of determining the target water source to be drawn by the water pump further includes the following steps. In response to detecting, by the water level detection sensing component, that the water level in the reservoir has dropped below the first threshold, the groundwater level has dropped below the second threshold, and tap water supply exists, tap water is determined as the target water source.

In some embodiments, the fire extinguishing and irrigation control method further includes the following steps. It is continuously detected, through the disaster situation detection sensing component, whether the fire risk still exists in the fire-prone area. In response to the fire risk no longer existing in the fire-prone area, the fire extinguishing sprinkler component is shut down.

In some embodiments, the fire extinguishing and irrigation control system further includes: an irrigation sprinkler component, the system settings include: a start time point of periodic irrigation, an end time point of periodic irrigation, and a preset irrigation trajectory, an operation of in response to determining, based on the analysis result, that there is no fire risk in the surrounding environment of the target building, irrigating the vegetation area of the target building according to the system settings of the fire extinguishing and irrigation control system includes the following steps. In response to determining, based on the analysis result, that there is no fire risk in the surrounding environment of the target building and a current time point has reached the start time point, the irrigation sprinkler component is controlled to conduct comprehensive irrigation over the vegetation area of the target building based on the preset irrigation trajectory.

In some embodiments, the fire extinguishing and irrigation control method further includes the following steps. It is continuously detected whether a changed current time point has reached the end time point. In response to the changed current time reaching the end time point, the irrigation sprinkler component is shut down.

In some embodiments, the fire extinguishing and irrigation control system further includes: an irrigation detection sensing component, the system settings further include: irrigation parameters of the irrigation sprinkler component, an operation of in response to determining, based on the analysis result, that there is no fire risk in the surrounding environment of the target building, irrigating the vegetation area of the target building according to the system settings of the fire extinguishing and irrigation control system includes the following steps. In response to determining, based on the analysis result, that there is no fire risk in the surrounding environment of the target building, a to-be-irrigated area within the vegetation area is determined based on a distribution location of the irrigation detection sensing component. The irrigation sprinkler component is controlled to conduct localized irrigation over the to-be-irrigated area based on the irrigation parameters, where the irrigation parameters include: a spraying angle of the irrigation sprinkler component and a progressive spraying distance of the irrigation sprinkler component.

In some embodiments, an operation of determining the to-be-irrigated area within the vegetation area based on the distribution location of the irrigation detection sensing component includes the following steps. Area soil moisture corresponding to the distribution location of the irrigation detection sensing component is detected. In response to the area soil moisture being lower than a third threshold, the to-be-irrigated area is determined based on the distribution location.

In some embodiments, an operation of controlling the irrigation sprinkler component to conduct localized irrigation over the to-be-irrigated areas based on the irrigation parameters includes the following steps. Target water source to be drawn by the water pump is determined. The irrigation sprinkler component is controlled to direct the target water source to the to-be-irrigated area for localized irrigation based on the irrigation parameters.

In some embodiments, an operation of determining the target water source to be drawn by the water pump includes the following steps. In response to detecting, by the water level detection sensing component, that water level in a reservoir equipped for the target building has not dropped below a first threshold, water stored in the reservoir is determined as the target water source.

In some embodiments, an operation of determining the target water source to be drawn by the water pump further includes the following steps. In response to detecting, by the water level detection sensing component, that the water level in the reservoir has dropped below the first threshold and groundwater level has not dropped below a second threshold, groundwater is determined as the target water source.

In some embodiments, an operation of determining the target water source to be drawn by the water pump further includes the following steps. In response to detecting, by the water level detection sensing component, that the water level in the reservoir has dropped below the first threshold, the groundwater level has dropped below the second threshold, and tap water supply exists, tap water is determined as the target water source.

In some embodiments, the fire extinguishing and irrigation control method further includes the following steps. It is continuously detected through the irrigation detection sensing component whether the area soil moisture remains lower than the third threshold. In response to the area soil moisture no longer being lower than the third threshold, the irrigation sprinkler component is shut down.

In some embodiments, the fire extinguishing and irrigation control method further includes the following steps. Zero-point calibration is performed on multiple components contained in the fire extinguishing and irrigation control system, where the multiple components include: an image acquisition component, a fire extinguishing sprinkler component, and an irrigation sprinkler component.

According to a second aspect, some embodiments of the present disclosure provide a fire extinguishing and irrigation control apparatus, including: an acquisition module, arranged for acquiring environmental data of a target building in real time, where the environmental data is used for recording changes in surrounding environment of the target building; an analysis module, arranged for conducting a fire risk analysis on the environmental data to obtain an analysis result, where the analysis result is used for determining whether there is a fire risk in the surrounding environment of the target building; a fire extinguishing module, arranged for in response to determining, based on the analysis result, that there is the fire risk in the surrounding environment of the target building, extinguishing fire in a fire-prone area of the target building; and an irrigation module, arranged for in response to determining, based on the analysis result, that there is no fire risk in the surrounding environment of the target building, irrigating a vegetation area of the target building according to system settings of the fire extinguishing and irrigation control system.

In some embodiments, the fire extinguishing and irrigation control system includes: an image acquisition component and a disaster situation detection sensing component, and the acquisition module is further arranged for: performing, through the image acquisition component, image recognition on the changes in the surrounding environment of the target building to obtain image data, and sensing, through the disaster situation detection sensing component, the changes in the surrounding environment of the target building to obtain sensing data; and determining the environmental data based on the image data and the sensing data.

In some embodiments, the fire extinguishing and irrigation control system further includes: a fire extinguishing sprinkler component, and the fire extinguishing module is further arranged for: in response to determining, based on the analysis result, that there is the fire risk in the surrounding environment of the target building, determining the fire-prone area of the target building and fire extinguishing parameters of the fire extinguishing sprinkler component based on a distribution location of the disaster situation detection sensing component, where the fire extinguishing parameters include: a spraying angle of the fire extinguishing sprinkler component, and a progressive spraying distance of the fire extinguishing sprinkler component; and controlling the fire extinguishing sprinkler component to extinguish the fire in the fire-prone area of the target building based on the fire extinguishing parameters.

In some embodiments, the fire extinguishing and irrigation control system further includes: a water pump, and the fire extinguishing module is further arranged for: determining target water source to be drawn by the water pump; and controlling, based on the fire extinguishing parameters, the fire extinguishing sprinkler component to direct the target water source to the fire-prone area of the target building for fire extinguishing.

In some embodiments, the fire extinguishing and irrigation control system further includes: a water level detection sensing component, and the fire extinguishing module is further arranged for: in response to detecting, by the water level detection sensing component, that water level in a reservoir equipped for the target building has not dropped below a first threshold, determining water stored in the reservoir as the target water source.

In some embodiments, the fire extinguishing module is further arranged for: in response to detecting, by the water level detection sensing component, that the water level in the reservoir has dropped below the first threshold and groundwater level has not dropped below a second threshold, determining groundwater as the target water source.

In some embodiments, the fire extinguishing module is further arranged for: in response to detecting, by the water level detection sensing component, that the water level in the reservoir has dropped below the first threshold, the groundwater level has dropped below the second threshold, and tap water supply exists, determining tap water as the target water source.

In some embodiments, the fire extinguishing module is further arranged for: continuously detecting, through the disaster situation detection sensing component, whether the fire risk still exists in the fire-prone area; and in response to the fire risk no longer existing in the fire-prone area, shutting down the fire extinguishing sprinkler component.

In some embodiments, the fire extinguishing and irrigation control system further includes: an irrigation sprinkler component, the system settings include: a start time point of periodic irrigation, an end time point of periodic irrigation, and a preset irrigation trajectory, and the irrigation module is further arranged for: in response to determining, based on the analysis result, that there is no fire risk in the surrounding environment of the target building and a current time point has reached the start time point, controlling the irrigation sprinkler component to conduct comprehensive irrigation over the vegetation area of the target building based on the preset irrigation trajectory.

In some embodiments, the irrigation module is further arranged for: continuously detecting whether a changed current time point has reached the end time point; and in response to the changed current time reaching the end time point, shutting down the irrigation sprinkler component.

In some embodiments, the fire extinguishing and irrigation control system further includes: an irrigation detection sensing component, the system settings further include: irrigation parameters of the irrigation sprinkler component, the irrigation module is further arranged for: in response to determining, based on the analysis result, that there is no fire risk in the surrounding environment of the target building, determining a to-be-irrigated area within the vegetation area based on a distribution location of the irrigation detection sensing component; and controlling the irrigation sprinkler component to conduct localized irrigation over the to-be-irrigated area based on the irrigation parameters, where the irrigation parameters include: a spraying angle of the irrigation sprinkler component and a progressive spraying distance of the irrigation sprinkler component.

In some embodiments, the irrigation module is further arranged for: detecting area soil moisture corresponding to the distribution location of the irrigation detection sensing component; and in response to the area soil moisture being lower than a third threshold, determining the to-be-irrigated area based on the distribution location.

In some embodiments, the irrigation module is further arranged for: determining target water source to be drawn by the water pump; and controlling the irrigation sprinkler component to direct the target water source to the to-be-irrigated area for localized irrigation based on the irrigation parameters.

In some embodiments, the irrigation module is further arranged for: in response to detecting, by the water level detection sensing component, that water level in a reservoir equipped for the target building has not dropped below a first threshold, determining water stored in the reservoir as the target water source.

In some embodiments, the irrigation module is further arranged for: in response to detecting, by the water level detection sensing component, that the water level in the reservoir has dropped below the first threshold and groundwater level has not dropped below a second threshold, determining groundwater as the target water source.

In some embodiments, the irrigation module is further arranged for: in response to detecting, by the water level detection sensing component, that the water level in the reservoir has dropped below the first threshold, the groundwater level has dropped below the second threshold, and tap water supply exists, determining tap water as the target water source.

In some embodiments, the irrigation module is further arranged for: continuously detecting through the irrigation detection sensing component whether the area soil moisture remains lower than the third threshold; and in response to the area soil moisture no longer being lower than the third threshold, shutting down the irrigation sprinkler component.

In some embodiments, the fire extinguishing and irrigation control apparatus further includes: a calibration module, arranged for performing zero-point calibration on multiple components contained in the fire extinguishing and irrigation control system, where the multiple components include: an image acquisition component, a fire extinguishing sprinkler component, and an irrigation sprinkler component.

According to a third aspect, some embodiments of the present disclosure provide a fire extinguishing and irrigation control system, including: a memory, arranged for storing an executable program; a processor, arranged for running the executable program to execute the following steps: acquiring environmental data of a target building in real time, where the environmental data is used for recording changes in surrounding environment of the target building; conducting a fire risk analysis on the environmental data to obtain an analysis result, where the analysis result is used for determining whether there is a fire risk in the surrounding environment of the target building; in response to determining, based on the analysis result, that there is the fire risk in the surrounding environment of the target building, extinguishing fire in a fire-prone area of the target building; and in response to determining, based on the analysis result, that there is no fire risk in the surrounding environment of the target building, irrigating a vegetation area of the target building according to system settings of the fire extinguishing and irrigation control system.

According to a fourth aspect, some embodiments of the present disclosure provide a non-transitory storage medium, where the non-transitory storage medium is arranged for storing an executable program, and when running the executable program, a device where the non-transitory storage medium is located is controlled to execute the following steps: acquiring environmental data of a target building in real time, where the environmental data is used for recording changes in surrounding environment of the target building; conducting a fire risk analysis on the environmental data to obtain an analysis result, where the analysis result is used for determining whether there is a fire risk in the surrounding environment of the target building; in response to determining, based on the analysis result, that there is the fire risk in the surrounding environment of the target building, extinguishing fire in a fire-prone area of the target building; and in response to determining, based on the analysis result, that there is no fire risk in the surrounding environment of the target building, irrigating a vegetation area of the target building according to system settings of the fire extinguishing and irrigation control system.

In some embodiments of the present disclosure, the environmental data of the target building in real time is acquired; the fire risk analysis is conducted on the environmental data to obtain the analysis result; in response to determining, based on the analysis result, that there is the fire risk in the surrounding environment of the target building, the fire is extinguished in the fire-prone area of the target building; and in response to determining, based on the analysis result, that there is no fire risk in the surrounding environment of the target building, the vegetation area of the target building is irrigated according to the system settings of the fire extinguishing and irrigation control system, thereby achieving the purpose of efficient resource utilization and intelligent management, and realizing the technical effect of improving resource utilization and safety of the fire extinguishing and irrigation control method, so as to solve the technical problem of low resource utilization and poor safety existing in fire extinguishing and irrigation control methods in the related art.

### BRIEF DESCRIPTION OF DRAWINGS

The drawings described here are provided to offer a further understanding of the present disclosure, and form a part of the present disclosure. The exemplary embodiments of the present disclosure and the descriptions thereof are used for explaining the present disclosure and do not constitute an improper limitation on the present disclosure. In the drawings:

FIG. 1 is a schematic diagram of a fire extinguishing and irrigation control system according to some embodiments of the present disclosure.

FIG. 2 is a flowchart of a fire extinguishing and irrigation control method according to some embodiments of the present disclosure.

FIG. 3 is a schematic diagram of relative positions of components according to some embodiments of the present disclosure.

FIG. 4 is a schematic diagram of a fire extinguishing control method according to some embodiments of the present disclosure.

FIG. 5 is a schematic diagram of a preset irrigation trajectory according to some embodiments of the present disclosure.

FIG. 6 is a schematic diagram of another preset irrigation trajectory according to some embodiments of the present disclosure.

FIG. 7 is a schematic diagram of an irrigation control method according to some embodiments of the present disclosure.

FIG. 8 is a schematic diagram of another irrigation method according to some embodiments of the present disclosure.

FIG. 9 is a schematic diagram of a zero calibration method according to some embodiments of the present disclosure.

FIG. 10 is a schematic diagram of another zero calibration method according to some embodiments of the present disclosure.

FIG. 11 is a schematic diagram of yet another zero calibration method according to some embodiments of the present disclosure.

FIG. 12 is a structural block diagram of a fire extinguishing and irrigation control device according to some embodiments of the present disclosure.

### DETAILED DESCRIPTION OF THE INVENTION

In order to enable a person having ordinary skill in the art to better understand the solution of the present disclosure, the following combines the drawings in embodiments of the present disclosure to clearly and completely describe the technical solution in the embodiments of the present disclosure. Obviously, the described embodiments are a part of the embodiments of the present disclosure rather than all of the embodiments. Based on the embodiments of the present disclosure, all other embodiments obtained by a person having ordinary skill in the art without making creative labor belong to the protection scope of the present disclosure.

It should be noted that the terms “first”, “second”, etc., in the specification and claims of the present disclosure and the above drawings are used for distinguishing similar objects and do not need to describe a specific order or sequence. It should be understood that such data can be interchanged under appropriate circumstances so that the embodiments of the present disclosure described here can be implemented in an order different from the one illustrated or described here. In addition, terms “includes” and “has” as well as any variations thereof are intended to cover non-exclusive inclusion, for example, a process, method, system, product, or device including a series of steps or units does not necessarily limit to those steps or units clearly listed but can include other steps or units not clearly listed or inherent to these processes, methods, products, or devices.

According to some embodiments of the present disclosure, a fire extinguishing and irrigation control method is provided. It should be noted that the steps shown in the flowchart of the drawings can be executed in a computer system through a group of computer executable instructions, and although logical order is shown in the flowchart, in some cases, the shown or described steps can be executed in an order different from the one herein.

This method embodiment can be executed in an electronic device or similar computing device containing a memory and a processor. Taking operation on a computer terminal as an example, the computer terminal may include at least one processor (the at least one processor may include but not limited to a Central Processing Unit (CPU), a Graphics Processing Unit (GPU), a Digital Signal Processing (DSP) chip, a Micro Controller Unit (MCU), a Field Programmable Gate Array (FPGA), a Neural-network Processor Unit (NPU), a Tensor Processing Unit (TPU), an Artificial Intelligence (AI) type processor, and other processing devices) and the memory for storing data. Optionally, the computer terminal may further include a transmission device for communication functions, an input-output device, and a display device. A person having ordinary skill in the art can understand that the above structure description is illustrative and does not limit the structure of the computer terminal. For example, the computer terminal may further include more or fewer components than described above, or have configurations different from those described above.

The memory can be arranged for storing computer programs, such as software programs and modules of applications, like the computer program corresponding to the fire extinguishing and irrigation control method in some embodiments of the present disclosure. The processor executes various functional applications and data processing through running the computer program stored in the memory, thereby realizing the fire extinguishing and irrigation control method. The memory may include a high-speed random access memory and may further include a non-transitory memory, such as at least one magnetic storage apparatus, at least one flash memory, or other non-transitory solid-state memories. In some instances, the memory may further include a memory remotely set relative to the processor, and the remote memory can be connected with a mobile terminal via a network. Instances of the network include but are not limited to an Internet, an intranet, a local area network, a mobile communication network, and combinations thereof.

The transmission apparatus is used for receiving or sending data over a network. Specific instances of the network may include a wireless network provided by a communication provider for the mobile terminal. In some instances, the transmission apparatus includes a Network Interface Controller (NIC), which can be connected with other network devices through a base station to communicate with the Internet. In some instances, the transmission apparatus may be a Radio Frequency (RF) module used for communicating with the Internet wirelessly.

The display equipment can be, for example, a Liquid Crystal Display (LCD) and a touch screen display (also referred to as “touch screen” or “touch display”). This LCD allows a user to interact with a user interface of the mobile terminal. In some embodiments, the mobile terminal has a Graphical User Interface (GUI), where a user can interact with the GUI through finger contact and/or gestures on a touch-sensitive surface. Human-machine interaction functions optionally include creating web pages, drawing, word processing, creating electronic documents, gaming, video conferencing, instant messaging, sending and receiving emails, call interfaces, playing digital video, playing digital music, and/or web browsing, etc. Executable instructions for performing the human-machine interaction functions are configured/stored in at least one computer program product or readable storage media executable by a processor.

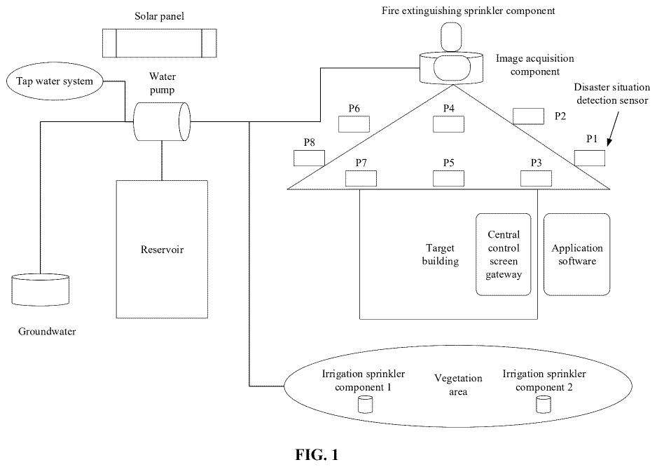

FIG. 1 is a schematic diagram of a fire extinguishing and irrigation control system according to some embodiments of the present disclosure. As shown in FIG. 1, the fire extinguishing and irrigation control system includes a fire extinguishing sprinkler component, an image acquisition component, a disaster situation detection sensing component (P1 to P8 shown in the figure), a solar panel, a water pump, a reservoir, groundwater, a tap water system, an irrigation sprinkler component, a central control screen gateway, and application software.

The central control screen gateway includes a Wi-Fi and Bluetooth dual-mode smart gateway used for receiving and displaying real-time data from multiple components and regulating the entire fire extinguishing and irrigation control system.

The fire extinguishing and irrigation control system uses the solar panel to power outdoor components including the fire extinguishing sprinkler component, the image acquisition component, the disaster situation detection sensing component, the water pump, and the irrigation sprinkler component, thereby reducing energy consumption. All electrical devices communicate through a Wi-Fi and Bluetooth Low Energy Mesh (BLE Mesh) network, forming a home network to achieve intelligent linkage.

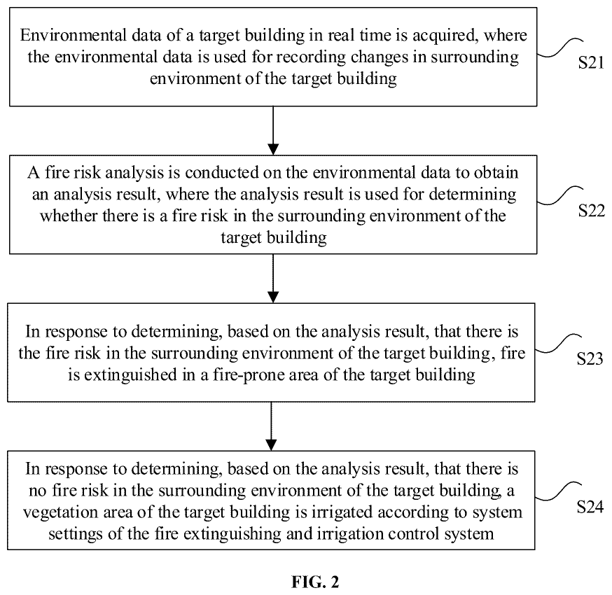

FIG. 2 is a flowchart of a fire extinguishing and irrigation control method according to some embodiments of the present disclosure. As shown in FIG. 2, the fire extinguishing and irrigation control method includes the following steps.

In step S21, environmental data of a target building in real time is acquired, where the environmental data is used for recording changes in surrounding environment of the target building.

In step S22, a fire risk analysis is conducted on the environmental data to obtain an analysis result, where the analysis result is used for determining whether there is a fire risk in the surrounding environment of the target building.

In step S23, in response to determining, based on the analysis result, that there is the fire risk in the surrounding environment of the target building, fire is extinguished in a fire-prone area of the target building.

In step S24, in response to determining, based on the analysis result, that there is no fire risk in the surrounding environment of the target building, a vegetation area of the target building is irrigated according to system settings of the fire extinguishing and irrigation control system.

The target building can be any building structure requiring fire protection and intelligent irrigation management, such as a residential house, commercial building, industrial facility, and so on.

The environmental data includes but is not limited to real-time surveillance video or images captured by an image acquisition component at the top of the target building, as well as real-time sensor data provided by disaster situation detection sensing components deployed at multiple points.

Exemplarily, when the fire extinguishing and irrigation control system of the target building is in an activated state, the fire extinguishing and irrigation control system collect, through the image acquisition component at the top of the target building and the disaster situation detection sensing components deployed at multiple points, real-time video images, temperature, smoke, and other environmental data around the target building to comprehensively record environmental changes around the target building. Subsequently, based on the environmental data, the fire extinguishing and irrigation control system analyzes whether there is the fire risk in the surrounding environment of the target building. When it is determined based on the analysis result that the fire risk exists in the surrounding environment of the target building, the fire extinguishing and irrigation control system first identifies the fire-prone area of the target building, then adjust the fire extinguishing sprinkler component at the top of the target building based on the fire-prone area to perform fire extinguishing on the fire-prone area until the fire risk is eliminated. Conversely, when it is determined based on the analysis result that no fire risk exists in the surrounding environment of the target building, the fire extinguishing and irrigation control system irrigates the vegetation area of the target building according to the system settings of the fire extinguishing and irrigation control system.

Based on the steps S21 to S24, the environmental data of the target building in real time is acquired. The fire risk analysis is conducted on the environmental data to obtain the analysis result. In response to determining, based on the analysis result, that there is the fire risk in the surrounding environment of the target building, the fire is extinguished in the fire-prone area of the target building; and in response to determining, based on the analysis result, that there is no fire risk in the surrounding environment of the target building, the vegetation area of the target building is irrigated according to the system settings of the fire extinguishing and irrigation control system, thereby achieving the purpose of efficient resource utilization and intelligent management, and realizing the technical effect of improving resource utilization and safety of the fire extinguishing and irrigation control method, so as to solve the technical problem of low resource utilization and poor safety existing in fire extinguishing and irrigation control methods in the related art.

Next, further introduction will be made regarding the fire extinguishing and irrigation control method in some embodiments of the present disclosure.

In some embodiments, the fire extinguishing and irrigation control system includes: an image acquisition component and a disaster situation detection sensing component, and in step S21, an operation of acquiring the environmental data of the target building in real time includes the following steps.

In step S211, image recognition is performed, through the image acquisition component, on the changes in the surrounding environment of the target building to obtain image data, and the changes in the surrounding environment of the target building are sensed, through the disaster situation detection sensing component, to obtain sensing data.

In step S212, the environmental data is determined based on the image data and the sensing data.

The image acquisition component is an Artificial Intelligence (AI) camera deployed at the top of the target building, arranged for capturing video images of the surrounding environment of the target building in real time and identifying fire image features within the video images to provide visual characteristics of the fire risk and the environmental data.

The disaster situation detection sensing component includes a temperature sensor and a smoke sensor deployed at the top of the target building, arranged for sensing temperature fluctuations and changes in smoke concentration in the surrounding environment in real time.

Exemplarily, it is assumed that the target building is a family residence, the AI camera at the top of the family residence captures 30 frames of surrounding environmental images per second and analyzes these images in real time to identify potential fire features such as the shape, color, dynamic changes of flames, and visual representations of smoke. Once the AI camera identifies suspected flames or abnormal smoke, structured image data including key information such as fire location, flame coverage area, smoke spread range, timestamp, and so on is immediately generated. Meanwhile, the temperature sensor and the smoke sensor continuously detect changes in temperature and smoke concentration in the surrounding environment. When the analysis result of the AI camera show that there are fire features in the surrounding environmental images, and temperature and smoke concentration change dramatically in a short time period, it is determined that there is the fire risk in the surrounding environment of the target building, so as to perform fire extinguishing operations on the fire-prone area.

Exemplarily, the image acquisition component and the disaster situation detection sensing component transmit image data and sensing data in real time to the central control screen gateway and mobile application software via a Wi-Fi communication method, thereby allowing users to view the fire risk in real time.

Based on the steps S211 to S212, through dual detection of the image acquisition component and the disaster situation detection sensing component, the fire extinguishing and irrigation control system not only discovers fires through the image recognition function of the AI camera but also verifies the authenticity of fires through quantified data from the temperature sensor and the smoke sensor, thereby avoiding false alarms or missed reports that might result from a single detection method, and improving the accuracy of system detection.

In some embodiments, the fire extinguishing and irrigation control system further includes: a fire extinguishing sprinkler component, and in step S23, an operation of in response to determining, based on the analysis result, that there is the fire risk in the surrounding environment of the target building, extinguishing the fire in the fire-prone area of the target building includes the following steps.

In step S231, in response to determining, based on the analysis result, that there is the fire risk in the surrounding environment of the target building, the fire-prone area of the target building and fire extinguishing parameters of the fire extinguishing sprinkler component are determined based on a distribution location of the disaster situation detection sensing component, where the fire extinguishing parameters include: a spraying angle of the fire extinguishing sprinkler component, and a progressive spraying distance of the fire extinguishing sprinkler component.

In step S232, the fire extinguishing sprinkler component is controlled to extinguish the fire in the fire-prone area of the target building based on the fire extinguishing parameters.

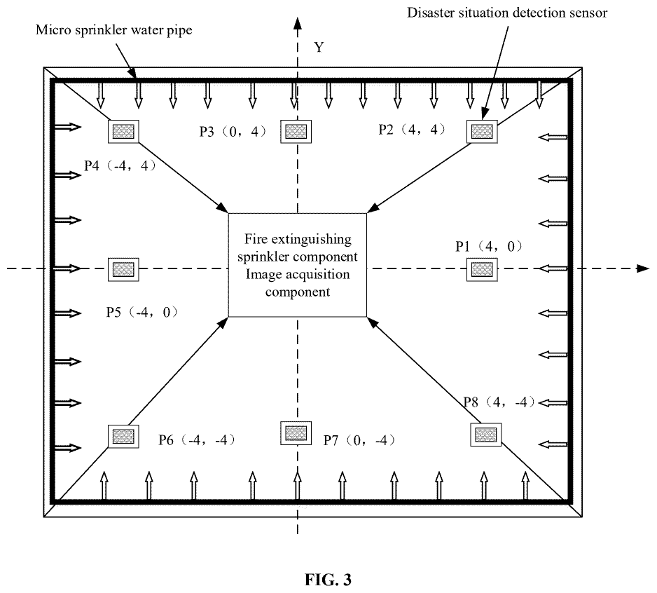

FIG. 3 is a schematic diagram of relative positions of components according to some embodiments of the present disclosure. As shown in FIG. 3, a top view of the target building is provided. The fire extinguishing sprinkler component and the image acquisition component are located at the top position of the target building. Eight disaster situation detection sensors deployed at multiple points are located on the central axis and diagonal lines at the top of the target building. Micro sprinkler water pipes are located around the top of the target building, supplied with water through micro sprinkler water pipes. Taking the central axis at the top of the target building as coordinate axes, the fire extinguishing sprinkler component and the image acquisition component are positioned at the origin (0,0), and positions of the eight disaster situation detection sensors are respectively: P1(4, 0), P2(4, 4), P3(0, 4), P4(−4, 4), P5(−4, 0), P6(−4, −4), P7(0,−4), and P8(4, −4).

The fire extinguishing sprinkler component is a multi-functional intelligent sprinkler apparatus that includes but is not limited to rotatable fire extinguishing sprinklers, distance-adjustable fire extinguishing sprinklers, and spiral irrigation sprinklers. The rotatable fire extinguishing sprinkler and the distance-adjustable fire extinguishing sprinkler automatically adjust direction and range based on the location of the fire risk, thereby achieving precise fire extinguishing operations. The spiral irrigation sprinkler is arranged for irrigation of green areas such as lawns, ensuring even and water-saving efficient irrigation through adjusting the number of rotations of the sprinkler and the amount of water sprayed.

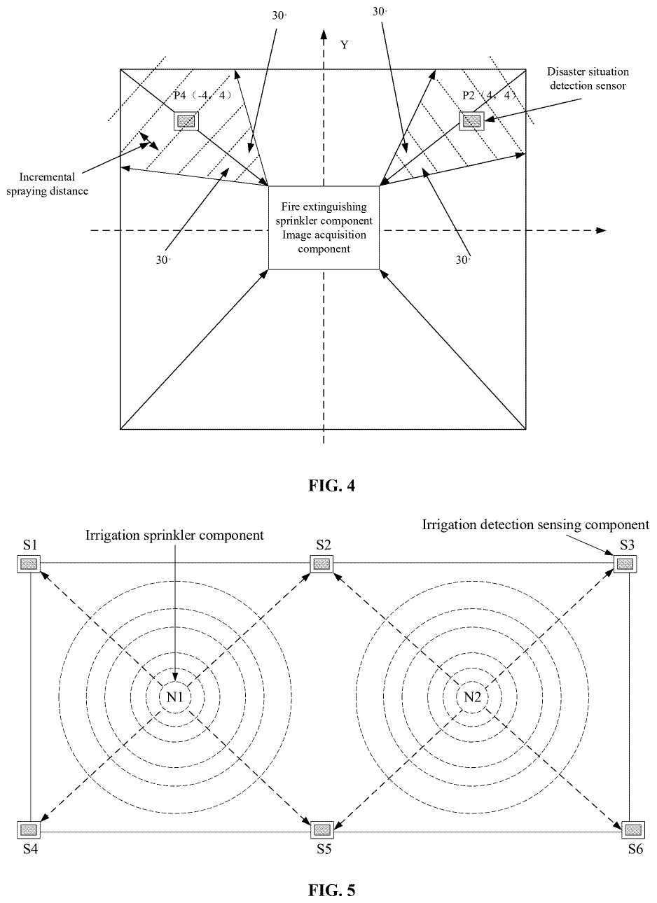

FIG. 4 is a schematic diagram of a fire extinguishing control method according to some embodiments of the present disclosure. As shown in FIG. 4, when fire risk is detected at position P2 or P4, the central control screen gateway controls the fire extinguishing sprinkler component to rotate to the location of the fire risk, starting from zero position, incrementally increasing the spraying distance to form a set of fan-shaped fire extinguishing lines until fully covering the fire-prone area.

Exemplarily, when there is the fire risk at position P2, the fire extinguishing sprinkler component will immediately respond. First, starting from the zero position, the fire extinguishing sprinkler component calculates the relative angle with the fire-prone area based on coordinate information of P2, automatically adjusts to a 45-degree direction to ensure that water is directly sprayed onto the fire-prone area. Subsequently, the fire extinguishing sprinkler component calculates the spraying angle and incremental spraying distance based on the distance between P2 and the origin (0, 0) to achieve step-by-step precise fire extinguishing. Meanwhile, in order to prevent the spread of fire, the central control screen gateway activates micro sprinklers to reduce the overall temperature of the target building, thereby preventing the fire source from spreading to other areas and protecting the building from further damage.

Exemplarily, in order to cope with possible simultaneous occurrence of multiple fire-prone areas, the fire extinguishing sprinkler component in the present disclosure is designed for deployment in multiple quantities. When the fire extinguishing and irrigation control system identifies multiple fire-prone areas, this system intelligently allocates multiple fire extinguishing sprinkler components, each targeting a specific fire-prone area for precise fire extinguishing, thus ensuring that even under complex disaster situations, through simultaneously activating multiple fire extinguishing sprinkler components from different angles and positions for fire extinguishing, delays or inefficiencies due to insufficient numbers of fire extinguishing sprinkler components are avoided, thereby reducing the risk of fire spread.

Based on steps S231 to S232, through determining the fire-prone area of the target building through the distribution locations of the disaster situation detection sensing components and determining fire extinguishing parameters of the fire extinguishing sprinkler component based on the fire-prone area, then performing fire extinguishing on the fire-prone area of the target building based on fire extinguishing parameters of the fire extinguishing sprinkler component, rapid response and precise fire extinguishing can be achieved, improving fire extinguishing efficiency while effectively controlling water resource consumption, ensuring environmental protection and economy of fire extinguishing operations, and reducing fire losses.

In some embodiments, the fire extinguishing and irrigation control system further includes: a water pump, and in step S232, an operation of controlling the fire extinguishing sprinkler component to extinguish the fire in the fire-prone area of the target building based on the fire extinguishing parameters includes the following steps.

In step S2321, target water source to be drawn by the water pump is determined.

In step S2322, he fire extinguishing sprinkler component is controlled, based on the fire extinguishing parameters, to direct the target water source to the fire-prone area of the target building for fire extinguishing.

The target water source is usable surrounding water resources, specifically including but not limited to reservoir water, groundwater, and tap water. In some embodiments, the priority ranking of the target water sources is as follows: the reservoir water takes precedence over the groundwater, and the groundwater takes precedence over the tap water, thereby achieving an efficient and environmentally friendly water resource management strategy.

Exemplarily, when there is the fire risk in the surrounding environment of the target building, the fire extinguishing and irrigation control system immediately detects the current usable surrounding water resource conditions, such as checking the availability status of the reservoir water, the groundwater, or the tap water, to determine the target water source for the water pump to extract. Subsequently, based on the spraying angle and incremental spraying distance of the fire extinguishing sprinkler component, the fire extinguishing sprinkler component is controlled to direct the target water source toward the fire-prone area of the target building, thereby performing fire extinguishing on the fire-prone area.

Based on steps S2321 to S2322, the intelligent selection mechanism based on the availability of the target water source ensures that in the event of an emergency fire, the fire extinguishing and irrigation control system can immediately mobilize the most suitable target water source. Through precisely controlling the spraying angle and incremental spraying distance of the fire extinguishing sprinkler component, the fire extinguishing and irrigation control system performs fire extinguishing on the fire-prone area, thereby protecting the safety of the target building and reducing fire losses.

In some embodiments, the fire extinguishing and irrigation control system further includes: a water level detection sensing component, in step S2321, an operation of determining the target water source to be drawn by the water pump includes the following steps. In response to detecting, by the water level detection sensing component, that water level in a reservoir equipped for the target building has not dropped below a first threshold, water stored in the reservoir is determined as the target water source.

The reservoir can be a swimming pool, a fire water reservoir, a rainwater collection pool, or any facility or container capable of storing large amounts of water resources.

The water level detection sensing component is a smart water level sensor. Specifically, the smart water level sensor integrates a microprocessor and a Bluetooth Low Energy (BLE) Mesh communication module, thereby enabling real-time measurement of water level height in the target water source and feedback of water level height to the central control screen gateway.

Exemplarily, when the fire extinguishing and irrigation control system is required to allocate water resources for fire extinguishing operations, the microprocessor within the water level detection sensing component detects the water level height of the reservoir in real time through a built-in water level measurement module of the microprocessor and transmits the water level height via the BLE Mesh network to the central control screen gateway. Upon receiving the water level height, the central control screen gateway makes a determination based on the preset first threshold. When the water level of the reservoir has not dropped below the first threshold, it indicates that the stored water in the reservoir is sufficient to meet current fire extinguishing demands. At this point, the fire extinguishing and irrigation control system will prioritize the stored water in the reservoir as the target water source for the water pump to extract for implementing fire extinguishing operations.

Exemplarily, it is assumed that the first threshold is 2 meters, at this time, the water level detected by the water level detection sensing component in the reservoir is 3 meters. After receiving water level data, the central control screen gateway quickly conducts threshold comparison analysis and confirms that the current water level in the reservoir has not dropped below the first threshold. Based on this determination, the central control screen gateway determines to prioritize the allocation of stored water in the reservoir and swiftly sends a start command to the water pump. In response to the start command issued by the central control screen gateway, the water pump begins to draw water from the reservoir and delivers the stored water in the reservoir to the fire sprinkler at the top of the target building to execute timely and effective fire extinguishing operations.

Based on the optional embodiments, through determining the stored water in the reservoir as the target water source when the water level has not fallen below the first threshold, it ensures that in the event of the fire risk, the fire extinguishing and irrigation control system can respond using existing adequate water resources, thereby avoiding delays or ineffective operations due to insufficient water sources. Additionally, prioritizing the use of stored water in the reservoir helps conserve public water sources, thereby reducing unnecessary water waste.

In some embodiments, in step S2321, an operation of determining the target water source to be drawn by the water pump further includes the following steps. In response to detecting, by the water level detection sensing component, that the water level in the reservoir has dropped below the first threshold and groundwater level has not dropped below a second threshold, groundwater is determined as the target water source.

Exemplarily, it is assumed that the first threshold is set to 1 meter, i.e., when the water level of the reservoir has not dropped below 1 meter, the fire extinguishing and irrigation control system prioritizes the stored water in the reservoir as the target water source. Conversely, when the water level of the reservoir has dropped below 1 meter, the availability of the groundwater is required to be determined. It assumed that the second threshold is 0.6 meters, and the water level detection sensing component detects that the current water level of the groundwater is 0.8 meters, at this time, the water level of the reservoir has dropped below the first threshold and the water level of the groundwater has not dropped below the second threshold, thereby allowing the groundwater to be used as the target water source.

Based on the optional embodiments, through real-time detection of the water levels of the reservoir and the groundwater, the fire extinguishing and irrigation control system in the present disclosure can quickly switch to the groundwater when the water level of the reservoir is insufficient, thereby avoiding interruptions during fire extinguishing due to water shortages and ensuring response speed in emergencies and continuity of routine maintenance.

In some embodiments, in step S2321, an operation of determining the target water source to be drawn by the water pump further includes the following steps. In response to detecting, by the water level detection sensing component, that the water level in the reservoir has dropped below the first threshold, the groundwater level has dropped below the second threshold, and tap water supply exists, tap water is determined as the target water source.

Exemplarily, it is assumed that the target building is a family residence supplied by a tap water system. During continuous high temperatures in summer, the water level of the reservoir decreases to 0.4 meters due to water evaporation. Meanwhile, the water level of groundwater further drops to 0.3 meters due to continuous extraction. At this time, both the reservoir and groundwater levels have dropped below preset thresholds and cannot provide sufficient water for fire extinguishing operations, thereby necessitating the use of the tap water as the target water source to perform fire extinguishing on the fire-prone area.

Exemplarily, when the water level of the reservoir has dropped below the first threshold, the water level of the groundwater has dropped below the second threshold, and the tap water system cannot supply water normally due to factors such as water cut-off or pipeline rupture, the central control screen gateway within the fire extinguishing and irrigation control system can connect via Wi-Fi or BLE Mesh network with a water resource management system in the community to request temporary use of shared water resources within the community, such as water from large reservoir towers or deep wells, to perform fire extinguishing on the fire-prone area. Specifically, the central control screen gateway first establishes a connection with the water resource management system in the community and sends a water request message containing current water conditions of the target building and urgent demand volume. Upon receiving the water request message, the water resource management system in the community sends a water allocation permit to the central control screen gateway of the target building via Wi-Fi, so as to open a valve connecting the water pump of the target building with a water supply network in the community. After receiving the water allocation permit, the central control screen gateway immediately activates the water pump to extract water from a large reservoir tower or deep well in the community to complete the fire extinguishing operation.

Based on the optional embodiments, through a water supply strategy for initially using the stored water from the reservoir, then using the groundwater, and finally intelligently switching to the tap water supply, it ensures that under various water supply shortages, sufficient water can still be provided quickly and continuously for fire extinguishing operations. Simultaneously, this water supply strategy minimizes dependence on the tap water system, thereby achieving priority utilization and efficient allocation of resources, and improving the resource utilization efficiency and safety of the fire extinguishing and irrigation control system.

In some embodiments, the fire extinguishing and irrigation control method further includes the following steps.

In step S31, it is continuously detected, through the disaster situation detection sensing component, whether the fire risk still exists in the fire-prone area.

In step S32, in response to the fire risk no longer existing in the fire-prone area, the fire extinguishing sprinkler component is shut down.

Exemplarily, during the process of using the target water source to perform fire extinguishing on the fire-prone area, the disaster situation detection sensing component continuously detects changes in the fire situation of the fire-prone area and transmits the sensing data such as temperature and smoke concentration to the central control screen gateway in real time. When the central control screen gateway detects that the temperature and smoke concentration in the surrounding environment of the target building have returned to a normal value range and no significant fluctuations occur within a preset time period, the central control screen gateway determines that the fire extinguishing operation in the fire-prone area has been completed and immediately sends a shutdown command to the fire extinguishing sprinkler component to avoid water resource waste. Simultaneously, the central control screen gateway sends a fire clearance notification to the mobile application software via Wi-Fi or BLE Mesh network, informing the user that the fire source has been successfully extinguished, along with detailed processes and timestamps of the fire extinguishing operation, helping the user understand the specific situation of this fire risk.

Based on the optional embodiments, through continuous monitoring and intelligent determination by the disaster situation detection sensing component, it can be ensured that the fire extinguishing sprinkler component is promptly shut down after the fire is effectively controlled, thereby avoiding water resource waste and improving resource utilization efficiency.

In some embodiments, the fire extinguishing and irrigation control system further includes: an irrigation sprinkler component, the system settings include: a start time point of periodic irrigation, an end time point of periodic irrigation, and a preset irrigation trajectory, in step S14, an operation of in response to determining, based on the analysis result, that there is no fire risk in the surrounding environment of the target building, irrigating the vegetation area of the target building according to the system settings of the fire extinguishing and irrigation control system includes the following steps. In response to determining, based on the analysis result, that there is no fire risk in the surrounding environment of the target building and a current time point has reached the start time point, the irrigation sprinkler component is controlled to conduct comprehensive irrigation over the vegetation area of the target building based on the preset irrigation trajectory.

The irrigation sprinkler component includes but is not limited to a spiral irrigation sprinkler, a micro-drip irrigation sprinkler, a misting irrigation sprinkler, and a rotary irrigation sprinkler.

The starting time point of periodic irrigation can be flexibly set according to different seasons, climate conditions, and specific requirements of vegetation. For example, during the hot and dry summer season, the starting time point is set at 4:00 AM when the relative humidity is higher and the temperature is lower, thereby reducing water evaporation and ensuring that vegetation receives sufficient moisture. In spring or autumn, the starting time point is adjusted to 6:00 AM to align with natural light and temperature changes, thereby promoting plant growth.

The setting of the ending time point for periodic irrigation should ensure thorough but not excessive irrigation, taking into account the impact of subsequent daily activities on water evaporation, maintaining soil moisture within an optimal range to promote vegetation growth. For instance, when the starting time point is set at 4:00 AM, and the ending time point is set at 4:30 AM to ensure irrigation is completed before strong sunlight increases evaporation. In spring or autumn, when the starting time point is 6:00 AM, and the ending time point is set at 6:30 AM or 7:00 AM, it is ensured that vegetation begins absorbing water shortly after sunrise while avoiding over-irrigation.

FIG. 5 is a schematic diagram of a preset irrigation trajectory according to some embodiments of the present disclosure. As shown in FIG. 5, the preset irrigation trajectory is a circular comprehensive irrigation trajectory, where N1, N2 represent irrigation sprinkler components, and S1 to S6 represent irrigation detection sensing components.

Exemplarily, taking the spiral irrigation sprinkler as an example, when irrigation starts, the spiral irrigation sprinkler sprays water from the center point, increasing the spraying distance by 0.5 meters after each spray, forming concentric circles until evenly covering the entire vegetation area.

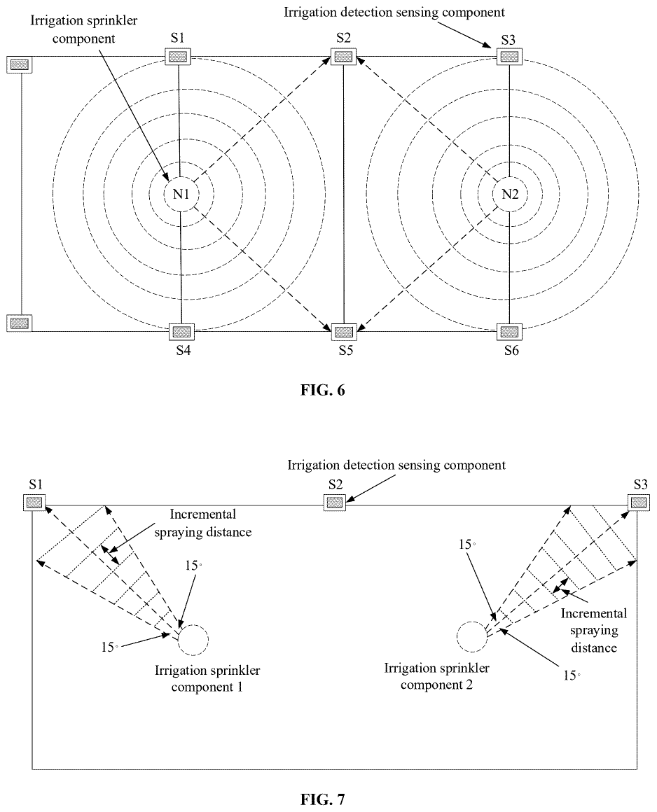

FIG. 6 is a schematic diagram of another preset irrigation trajectory according to some embodiments of the present disclosure. As shown in FIG. 6, N1, N2 represent irrigation sprinkler components, and S1 to S6 represent irrigation detection sensing components.

Exemplarily, it is assumed that the vegetation area of the target building is symmetrical, two irrigation sprinkler components are installed at the edge of the vegetation area. When irrigation starts, the two irrigation sprinkler components work simultaneously in opposite directions. The irrigation trajectories of the two irrigation sprinkler components move from the edge toward the center to form symmetrical semi-circular irrigation trajectories.

Exemplarily, it is assumed that the starting time point for periodic irrigation in the system settings is 4:00 AM and the ending time point is 4:30 AM, with a preset irrigation trajectory of a circular comprehensive irrigation path. When the fire extinguishing and irrigation control system detects no fire risk around the target building and the current time point has reached the starting time point for periodic irrigation, the spiral irrigation sprinkler will, based on the system settings, perform comprehensive irrigation on the vegetation area of the target building according to the circular comprehensive irrigation trajectory.

Based on the optional embodiments, the fire extinguishing and irrigation control system can, when there is no fire risk around the target building and the starting time point has been reached, uniformly and comprehensively irrigate the vegetation area of the target building according to the preset irrigation trajectory, thereby ensuring moisture requirements of the vegetation area. Through precise control of irrigation time and scope, it avoids waste of water resources.

In some embodiments, the fire extinguishing and irrigation control method further includes the following steps.

In step S41, it is continuously detected whether a changed current time point has reached the end time point.

In step S42, in response to the changed current time reaching the end time point, the irrigation sprinkler component is shut down.

Exemplarily, the fire extinguishing and irrigation control system includes a real-time clock module for detecting the changed current time point. Specifically, the real-time clock module continuously tracks the passage of time and compares the changed current time point with the preset irrigation ending time point to determine whether the preset irrigation ending time point has been reached. When the changed current time point reaches the preset irrigation ending time point, the real-time clock module sends a time arrival signal to the central control screen gateway. Upon receiving the time arrival signal, the central control screen gateway immediately responds by executing a shutdown command to cut off power or water supply to the irrigation sprinkler component, stopping water spraying, thereby ensuring that the irrigation process is completed within the predetermined time period, meeting the moisture requirements of vegetation while avoiding unnecessary waste of water resources.

Exemplarily, the central control screen gateway in the fire extinguishing and irrigation control system further connects with the internet via Wi-Fi to access an Application Programming Interface (API) provided by a weather service provider. Specifically, the central control screen gateway sends a HyperText Transfer Protocol (HTTP) or HTTPS request to a weather forecast API server to obtain weather forecast data for a specific geographic location. After receiving the weather forecast data, the central control screen gateway parses information returned by the API to extract relevant weather trend and precipitation forecast, thereby intelligently adjusting the irrigation strategy. For example, when rain is predicted, the fire extinguishing and irrigation control system will automatically postpone the irrigation schedule to avoid wasting water resources. When dry conditions are predicted, the fire extinguishing and irrigation control system will irrigate earlier or extend the irrigation duration.

Based on steps S41 to S42, through continuously detecting whether the changed current time point has reached the ending time point and shutting down the irrigation sprinkler component at the ending time point, automated and intelligent irrigation control is achieved. This ensures that an irrigation time period strictly follows a user-defined cycle, avoiding uncertainties associated with manual operations, while further reducing unnecessary energy use, contributing to lowering overall energy consumption.

In some embodiments, the fire extinguishing and irrigation control system further includes: an irrigation detection sensing component, the system settings further include: irrigation parameters of the irrigation sprinkler component, in step S24, an operation of in response to determining, based on the analysis result, that there is no fire risk in the surrounding environment of the target building, irrigating the vegetation area of the target building according to the system settings of the fire extinguishing and irrigation control system includes the following steps.

In step S241, in response to determining, based on the analysis result, that there is no fire risk in the surrounding environment of the target building, a to-be-irrigated area within the vegetation area is determined based on a distribution location of the irrigation detection sensing component.

In step S242, the irrigation sprinkler component is controlled to conduct localized irrigation over the to-be-irrigated area based on the irrigation parameters, where the irrigation parameters include: a spraying angle of the irrigation sprinkler component and a progressive spraying distance of the irrigation sprinkler component.

The irrigation detection sensing component includes but is not limited to a capacitive soil moisture sensor, a resistive soil moisture sensor, a soil moisture probe, and others, used for monitoring moisture content in soil to determine whether the vegetation area of the target building requires irrigation.

Exemplarily, the vegetation area of the target building is divided into multiple small areas, with the capacitive soil moisture sensor arranged for each small area, thereby determining at least one area to be irrigated within the vegetation area based on the distribution positions of the irrigation detection sensing components. Once the at least one area to be irrigated is determined, the central control screen gateway calculates the spraying angle and incremental spraying distance of the irrigation sprinkler component based on the relative position between the irrigation sprinkler component and the current area to be irrigated.

Exemplarily, first, based on the straight-line distance and direction angle between the irrigation sprinkler component and the current area to be irrigated, the spraying angle of the irrigation sprinkler component is calculated so that the spraying direction of the irrigation sprinkler component faces the center point of the at least one area to be irrigated. Meanwhile, based on the size of the at least one area to be irrigated and the coverage range of the irrigation sprinkler head, an appropriate incremental spraying distance is calculated to ensure that the irrigation sprinkler component can evenly cover the entire area to be irrigated. Subsequently, based on the spraying angle and incremental spraying distance, the irrigation sprinkler component performs localized irrigation on the at least one area to be irrigated, thereby achieving precise irrigation of the vegetation area.

Based on steps S241 to S242, when no fire risk exists in the surrounding environment of the target building, the at least one area to be irrigated within the vegetation area are determined based on the distribution positions of the irrigation detection sensing components. Then, irrigation parameters are calculated based on the relative position between the at least one area to be irrigated and the irrigation sprinkler component. Finally, based on these irrigation parameters, the irrigation sprinkler component performs localized irrigation on the at least one area to be irrigated, thereby enabling targeted delivery of water resources to the at least one area to be irrigated, and improving the utilization efficiency of water resources.

In some embodiments, in step S241, an operation of determining the to-be-irrigated area within the vegetation area based on the distribution location of the irrigation detection sensing component includes the following steps.

In step S2411, area soil moisture corresponding to the distribution location of the irrigation detection sensing component is detected.

In step S2412, in response to the area soil moisture being lower than a third threshold, the to-be-irrigated area is determined based on the distribution location.

Exemplarily, multiple irrigation detection sensing components distributed across the vegetation area continuously detect the soil moisture of the current area and transmit soil moisture data to the central control screen gateway via the BLE Mesh network. The central control screen gateway compares the soil moisture of areas corresponding to multiple irrigation detection sensing components with a preset third threshold in real time. When the soil moisture of an area corresponding to any irrigation detection sensing component falls below the third threshold, the area to be irrigated is determined based on the distribution position of that irrigation detection sensing component.

FIG. 7 is a schematic diagram of an irrigation control method according to some embodiments of the present disclosure. As shown in FIG. 7, a vegetation area is arranged with three irrigation detection sensing components (S1 to S3) and two irrigation sprinkler components. The three irrigation detection sensing components are located at the horizontal edges of the vegetation area, with an irrigation detection sensing component 2 situated at the midpoint of the line connecting an irrigation detection sensing component 1 and an irrigation detection sensing component 3. An irrigation sprinkler component 1 is located in the central area between the irrigation detection sensing component 1 and the irrigation detection sensing component 2. An irrigation sprinkler component 2 is located in the central area between the irrigation detection sensing component 2 and the irrigation detection sensing component 3. At this time, areas where the irrigation detection sensing component 1 and the irrigation detection sensing component 3 are located are the areas to be irrigated. Based on the straight-line distance between the irrigation detection sensing components and the irrigation sprinkler components, the irrigation sprinkler component 1 performs localized irrigation on the area where the irrigation detection sensing component 1 is located, and the irrigation sprinkler component 2 performs localized irrigation on the area where the irrigation detection sensing component 3 is located.

Exemplarily, when the irrigation sprinkler component 1 performs localized irrigation on the area where the irrigation detection sensing component 1 is located, based on the relative position between the irrigation detection sensing component 1 and the irrigation sprinkler component 1, calculated irrigation parameters are as follows. The spraying angle of the irrigation sprinkler component 1 is 30°, and the incremental spraying distance is 0.5 meters. Further, based on these irrigation parameters, the central control screen gateway schedules the irrigation sprinkler component 1 to rotate the spraying direction of the irrigation sprinkler component 1 to align with the center point of the irrigation detection sensing component 1, and controls the irrigation sprinkler component 1 to start watering at a set spraying angle of 30°. After each watering action, the irrigation sprinkler component 1 sprays water according to the incremental spraying distance of 0.5 meters, ensuring that the spraying trajectory covers the entire area to be irrigated from the irrigation sprinkler component 1 to the irrigation detection sensing component 1, thereby completing localized irrigation for the area to be irrigated. Since the irrigation detection sensing component 3 is symmetrically positioned relative to the irrigation detection sensing component 1, the calculated irrigation parameters are the same, thus the process by which the irrigation sprinkler component 2 performs localized irrigation on the area where the irrigation detection sensing component 3 is located is similar and will not be repeated here.

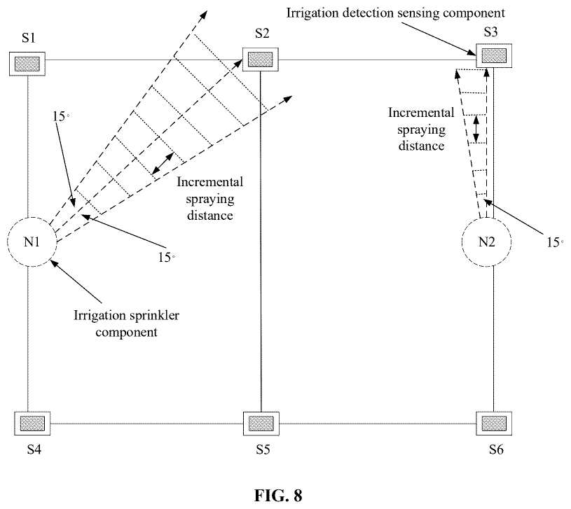

FIG. 8 is a schematic diagram of another irrigation method according to some embodiments of the present disclosure. As shown in FIG. 8, a vegetation area is arranged with six irrigation detection sensing components and two irrigation sprinkler components. The six irrigation detection sensing components are evenly distributed along the horizontal edges of the vegetation area, and the two irrigation sprinkler components are respectively located at the midpoints of the longitudinal edges of the vegetation area. At this time, the areas where the irrigation detection sensing component 2 and the irrigation detection sensing component 3 are located are the areas to be irrigated. Based on the straight-line distance between the irrigation detection sensing components and the irrigation sprinkler components, the irrigation sprinkler component 1 performs localized irrigation on the area where the irrigation detection sensing component 2 is located, and the irrigation sprinkler component 2 performs localized irrigation on the area where the irrigation detection sensing component 3 is located.

Exemplarily, when the irrigation sprinkler component 2 performs localized irrigation on the area where the irrigation detection sensing component 3 is located, since the irrigation sprinkler component 2 and the irrigation detection sensing component 3 are both located at the edge of the current vegetation area, based on the relative position between the irrigation detection sensing component 3 and the irrigation sprinkler component 2, the calculated irrigation parameters are as follows. The spraying angle of irrigation sprinkler component 2 is 15°, and the incremental spraying distance is 0.5 meters. Further, based on these irrigation parameters, the central control screen gateway schedules the irrigation sprinkler component 2 to rotate until the right-side spraying line of the irrigation sprinkler component 2 aligns with the center point of the irrigation detection sensing component 3, and controls the irrigation sprinkler component 2 to start watering at a set spraying angle of 15°. After each watering action, the irrigation sprinkler component 2 sprays water according to the incremental spraying distance of 0.5 meters, ensuring that the spraying trajectory covers the entire area to be irrigated from the irrigation sprinkler component 2 to the irrigation detection sensing component 3, thereby completing localized irrigation for the area to be irrigated.

Based on steps S2411 to S2412, through continuously monitoring the soil moisture at positions corresponding to irrigation detection sensing components deployed in the vegetation area and determining any area with humidity below the preset third threshold as an area to be irrigated, precise and timely irrigation intervention can be achieved, thus preventing damage to vegetation due to drought while avoiding over-irrigation of other areas.

In some embodiments, in step S242, an operation of controlling the irrigation sprinkler component to conduct localized irrigation over the to-be-irrigated areas based on the irrigation parameters includes the following steps.

In step S2421, target water source to be drawn by the water pump is determined.

In step S2422, the irrigation sprinkler component is controlled to direct the target water source to the to-be-irrigated area for localized irrigation based on the irrigation parameters.

Exemplarily, when there is an area to be irrigated in the vegetation area of the target building, the target water source corresponding to the water pump includes multiple sources. It is necessary to sequentially determine the availability of the target water sources based on the priority ranking of the target water sources. Further, after determining the target water source, the central control screen gateway controls the irrigation sprinkler component based on irrigation parameters to direct the target water source toward the area to be irrigated, so as to perform localized irrigation on the area to be irrigated.

Based on steps S2421 to S2422, according to changes in water resources around the target building, intelligently adjusting the irrigation strategy and prioritizing the use of renewable or low-cost water sources as the target water source can improve the utilization efficiency of water resources while reducing the cost of irrigation water.

In some embodiments, in step S2421, an operation of determining the target water source to be drawn by the water pump includes the following steps. In response to detecting, by the water level detection sensing component, that water level in a reservoir equipped for the target building has not dropped below a first threshold, water stored in the reservoir is determined as the target water source.

Exemplarily, when the fire extinguishing and irrigation control system is required to allocate water resources for localized irrigation, the microprocessor in the water level detection sensing component detects, by using a water level measurement module built in the microprocessor, the water level height of the reservoir in real time and transmits the water level height to the central control screen gateway via the BLE Mesh network. Upon receiving the water level height, the central control screen gateway makes a determination based on a preset first threshold. When the water level of the reservoir is higher than the first threshold, it indicates that the reserve water in the reservoir is sufficient to meet current irrigation requirements. At this point, the fire extinguishing and irrigation control system will prioritize the reserve water within the reservoir as the target water source for the water pump to draw from, implementing irrigation operations.

Exemplarily, it is assumed that the first threshold is 70% of the reservoir capacity. At this time, the water level detected by the water level detection sensing component is 80% of the reservoir capacity. After receiving the water level data, the central control screen gateway quickly conducts threshold comparison analysis and confirms that the current water level of the reservoir has not dropped below the first threshold. Based on this determination, the central control screen gateway determines to prioritize the allocation of reserve water within the reservoir and promptly sends a start command to the water pump. In response to the start command issued by the central control screen gateway, the water pump begins to draw water from the reservoir and transports the reserve water to the irrigation sprinkler component in the vegetation area of the target building.

Based on the optional embodiments, through responding to a monitoring result of the water level detection sensing component, when it is confirmed that the water level of the reservoir has not dropped below the preset first threshold, using the reserve water within the reservoir as the target water source ensures that existing reserves are utilized preferentially when water resources are abundant, thereby reducing dependence on external water sources.

In some embodiments, in step S2421, an operation of determining the target water source to be drawn by the water pump further includes the following steps. In response to detecting, by the water level detection sensing component, that the water level in the reservoir has dropped below the first threshold and groundwater level has not dropped below a second threshold, groundwater is determined as the target water source.

Exemplarily, it is assumed that the first threshold is set to 2 meters, meaning that when the water level of the reservoir has not dropped below 2 meters, the fire extinguishing and irrigation control system prioritizes the reserve water within the reservoir as the target water source. Conversely, when the water level of the reservoir has dropped below 2 meters, it is necessary to further determine the availability of the groundwater. It is assumed that the second threshold is 1 meter, and the water level detection sensing component detects that the current groundwater level is 1.5 meters. At this time, the water level of the reservoir has dropped below the first threshold while the groundwater level has not dropped below the second threshold. The groundwater is set as the target water source to irrigate the vegetation area.

Based on the optional embodiments, through real-time monitoring of the water level changes of the reservoir and the groundwater by the water level detection sensing component, when the water level of the reservoir has dropped below the first threshold and the groundwater level has not dropped below the second threshold, setting the groundwater as the target water source ensures the continuity of irrigation operations while avoiding the risk of water source depletion, thereby maintaining the stable operation of the fire extinguishing and irrigation control system.

In some embodiments, in step S2421, an operation of determining the target water source to be drawn by the water pump further includes the following steps. In response to detecting, by the water level detection sensing component, that the water level in the reservoir has dropped below the first threshold, the groundwater level has dropped below the second threshold, and tap water supply exists, tap water is determined as the target water source.

Exemplarily, when the water level in the reservoir has dropped below the first threshold and the groundwater level has dropped below the second threshold, it indicates that the conventional water reserves are insufficient to meet the current irrigation requirements. At this time, the central control screen gateway interconnects with the smart water meter in the target building through a Wi-Fi or BLE Mesh network and determines whether the current water supply system is operating normally based on real-time data such as flow rate and water pressure obtained from the smart water meter. When a water supply system exists and the water supply is normal, the tap water is set as the target water source.

Based on the optional embodiments, when the reserve water resources in the reservoir and the groundwater are insufficient, setting the tap water as the target water source ensures the continuity of irrigation operations, thereby improving the resource utilization efficiency and adaptability of the fire extinguishing and irrigation control system.

In some embodiments, the fire extinguishing and irrigation control method further includes the following steps.

In step S51, it is continuously detected through the irrigation detection sensing component whether the area soil moisture remains lower than the third threshold.

In step S52, in response to the area soil moisture no longer being lower than the third threshold, the irrigation sprinkler component is shut down.

Exemplarily, during the localized irrigation of the area to be irrigated by the irrigation sprinkler component, the irrigation detection sensing component continuously detects the soil moisture of the area to be irrigated. When the detected soil moisture of the area recovers to or exceeds the third threshold, it indicates that the area has been sufficiently irrigated and does not require further water supply. At this time, the central control screen gateway controls the irrigation sprinkler component to shut down via the BLE Mesh network or Wi-Fi, stopping the water supply.

Based on steps S51 to S52, through continuously detecting the area soil moisture and subsequently shutting down the irrigation sprinkler component when the area soil moisture is not lower than the third threshold, the waste of water resources caused by excessive water supply can be avoided.

In some embodiments, the fire extinguishing and irrigation control method further includes the following steps. Zero-point calibration is performed on multiple components contained in the fire extinguishing and irrigation control system, where the multiple components include: an image acquisition component, a fire extinguishing sprinkler component, and an irrigation sprinkler component.

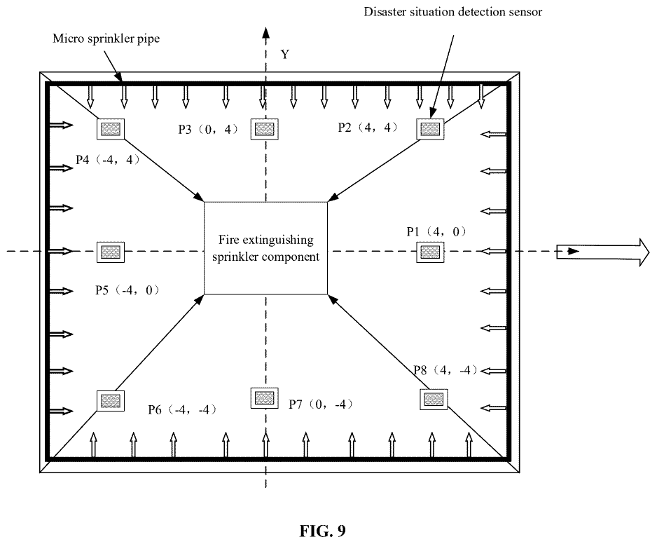

FIG. 9 is a schematic diagram of a zero position calibration method according to some embodiments of the present disclosure. As shown in FIG. 9, during installation of the fire extinguishing sprinkler component, a direction indicated by the arrow in the figure represents the relative zero position (0°). The fire extinguishing sprinkler component starts rotating counterclockwise from 0° and return to 0° after completing fire extinguishing. The disaster situation detection sensing components from the disaster situation detection sensing component 1 to the disaster situation detection sensing component 8 are distributed counterclockwise at 45° intervals on the top of the target building.

Exemplarily, it is assumed that there is the fire risk at the location of the disaster situation detection sensing component 2, the central control screen gateway will control the fire extinguishing sprinkler component to rotate from 0° to 45° to perform fire extinguishing on the area where the disaster situation detection sensing component 2 is located, and then, upon completion of fire extinguishing, control the fire extinguishing sprinkler component to return to 0°.

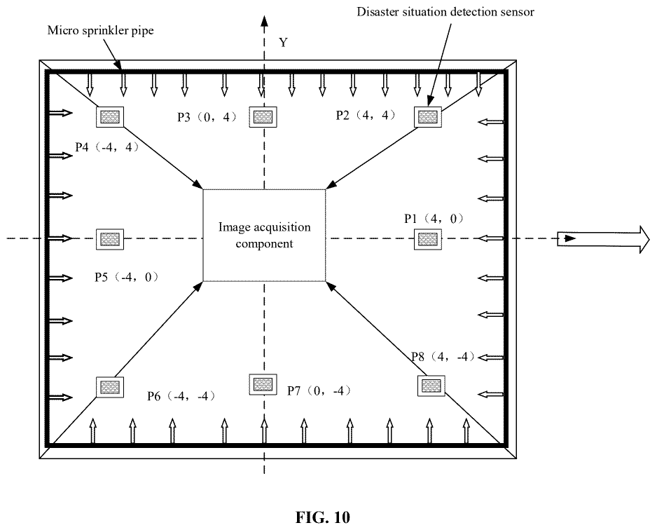

FIG. 10 is a schematic diagram of another zero position calibration method according to some embodiments of the present disclosure. As shown in FIG. 10, during installation of the image acquisition component, it is synchronized with the relative zero position of the fire extinguishing sprinkler component according to the direction indicated by the arrow in the figure. The image acquisition component can start rotating counterclockwise from 0° and determine the position of the fire risk based on the rotation angle.

Exemplarily, when the image acquisition component rotates to 20° and detects the fire risk in that direction, while combining the sensing data detected by disaster situation detection sensing components at 0° and 45° directions, it confirms that there is the fire risk near the 20° position. The central control screen gateway responds to this fire risk by controlling the fire extinguishing sprinkler component to rotate to 20° for spraying water, thereby performing precise fire extinguishing operations.

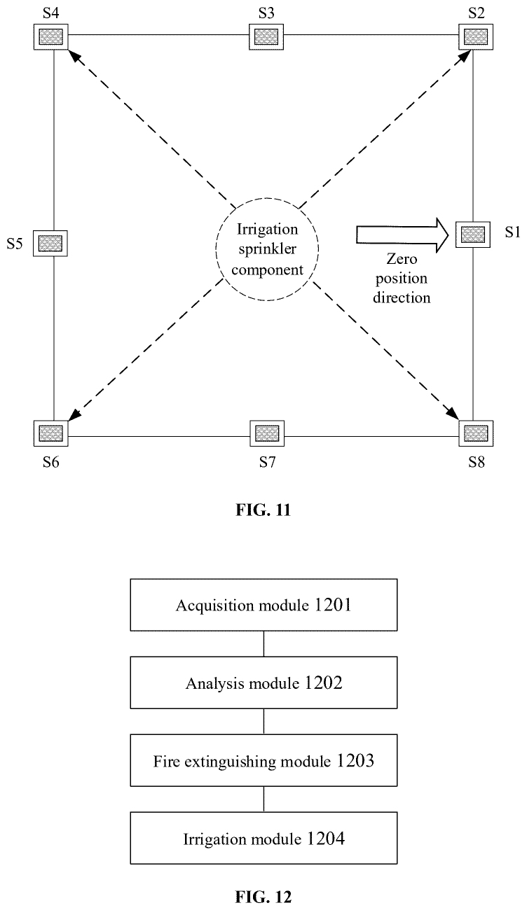

FIG. 11 is a schematic diagram of another zero position calibration method according to some embodiments of the present disclosure. As shown in FIG. 11, during installation of the irrigation sprinkler component, it is synchronized with the relative zero position of the fire extinguishing sprinkler component according to the direction indicated by the arrow in the figure. During irrigation, the irrigation sprinkler component can start rotating counterclockwise from 0° and return to 0° upon completion of irrigation.

Based on the optional embodiments, through zero synchronization of the image acquisition component, the fire extinguishing sprinkler component, and the irrigation sprinkler component, it ensures that reference positions of each component in the fire extinguishing and irrigation control system are consistent upon startup, which not only enhances the overall coordination of the fire extinguishing and irrigation control system but also, in case of fire risk or irrigation requirements, controls each component to rotate to a correct angle, thereby improving the accuracy and efficiency of fire extinguishing and irrigation operations.

Through the description of the above implementation methods, a person having ordinary skill in the art can clearly understand that the method according to the above embodiments can be implemented by means of software plus necessary general hardware platform, and certainly can also be implemented through hardware, but in many cases, the former is a better implementation method. Based on this understanding, the technical solution of the present disclosure essentially or the part contributing to the related art can be embodied in the form of a computer software product. This computer software product is stored in a storage medium (such as ROM/RAM, magnetic disk, optical disc), including several instructions to enable a terminal device (which can be a mobile phone, a computer, a server, or a network device, etc.) to execute the method described in various embodiments of the present disclosure.

In some embodiments of the present disclosure, a fire extinguishing and irrigation control apparatus for realizing the above embodiments and exemplary implementation methods is further provided, where details already explained will not be repeated. As used below, the term “module” can be a combination of software and/or hardware that achieves predetermined functions. Though the apparatus described in the following embodiments is exemplarily realized through software, realization through hardware or a combination of software and hardware is further possible and conceived.

FIG. 12 is a structural block diagram of a fire extinguishing and irrigation control apparatus according to some embodiments of the present disclosure. As shown in FIG. 12, the fire extinguishing and irrigation control apparatus includes:
an acquisition module 1201, arranged for acquiring environmental data of a target building in real time, where the environmental data is used for recording changes in surrounding environment of the target building;
an analysis module 1202, arranged for conducting a fire risk analysis on the environmental data to obtain an analysis result, where the analysis result is used for determining whether there is a fire risk in the surrounding environment of the target building;
a fire extinguishing module 1203, arranged for in response to determining, based on the analysis result, that there is the fire risk in the surrounding environment of the target building, extinguishing fire in a fire-prone area of the target building; and
an irrigation module 1204, arranged for in response to determining, based on the analysis result, that there is no fire risk in the surrounding environment of the target building, irrigating a vegetation area of the target building according to system settings of the fire extinguishing and irrigation control system.

In some embodiments, the fire extinguishing and irrigation control system includes: an image acquisition component and a disaster situation detection sensing component, and the acquisition module 1201 is further arranged for: performing, through the image acquisition component, image recognition on the changes in the surrounding environment of the target building to obtain image data, and sensing, through the disaster situation detection sensing component, the changes in the surrounding environment of the target building to obtain sensing data; and determining the environmental data based on the image data and the sensing data.

In some embodiments, the fire extinguishing and irrigation control system further includes: a fire extinguishing sprinkler component, and the fire extinguishing module 1203 is further arranged for: in response to determining, based on the analysis result, that there is the fire risk in the surrounding environment of the target building, determining the fire-prone area of the target building and fire extinguishing parameters of the fire extinguishing sprinkler component based on a distribution location of the disaster situation detection sensing component, where the fire extinguishing parameters include: a spraying angle of the fire extinguishing sprinkler component, and a progressive spraying distance of the fire extinguishing sprinkler component; and controlling the fire extinguishing sprinkler component to extinguish the fire in the fire-prone area of the target building based on the fire extinguishing parameters.

In some embodiments, the fire extinguishing and irrigation control system further includes: a water pump, and the fire extinguishing module 1203 is further arranged for: determining target water source to be drawn by the water pump; and controlling, based on the fire extinguishing parameters, the fire extinguishing sprinkler component to direct the target water source to the fire-prone area of the target building for fire extinguishing.

In some embodiments, the fire extinguishing and irrigation control system further includes: a water level detection sensing component, and the fire extinguishing module 1203 is further arranged for: in response to detecting, by the water level detection sensing component, that water level in a reservoir equipped for the target building has not dropped below a first threshold, determining water stored in the reservoir as the target water source.

In some embodiments, the fire extinguishing module 1203 is further arranged for: in response to detecting, by the water level detection sensing component, that the water level in the reservoir has dropped below the first threshold and groundwater level has not dropped below a second threshold, determining groundwater as the target water source.

In some embodiments, the fire extinguishing module 1203 is further arranged for: in response to detecting, by the water level detection sensing component, that the water level in the reservoir has dropped below the first threshold, the groundwater level has dropped below the second threshold, and tap water supply exists, determining tap water as the target water source.

In some embodiments, the fire extinguishing module 1203 is further arranged for: continuously detecting, through the disaster situation detection sensing component, whether the fire risk still exists in the fire-prone area; and in response to the fire risk no longer existing in the fire-prone area, shutting down the fire extinguishing sprinkler component.

In some embodiments, the fire extinguishing and irrigation control system further includes: an irrigation sprinkler component, the system settings include: a start time point of periodic irrigation, an end time point of periodic irrigation, and a preset irrigation trajectory, and the irrigation module 1204 is further arranged for: in response to determining, based on the analysis result, that there is no fire risk in the surrounding environment of the target building and a current time point has reached the start time point, controlling the irrigation sprinkler component to conduct comprehensive irrigation over the vegetation area of the target building based on the preset irrigation trajectory.

In some embodiments, the irrigation module 1204 is further arranged for: continuously detecting whether a changed current time point has reached the end time point; and in response to the changed current time reaching the end time point, shutting down the irrigation sprinkler component.

In some embodiments, the fire extinguishing and irrigation control system further includes: an irrigation detection sensing component, the system settings further include: irrigation parameters of the irrigation sprinkler component, the irrigation module 1204 is further arranged for: in response to determining, based on the analysis result, that there is no fire risk in the surrounding environment of the target building, determining a to-be-irrigated area within the vegetation area based on a distribution location of the irrigation detection sensing component; and controlling the irrigation sprinkler component to conduct localized irrigation over the to-be-irrigated area based on the irrigation parameters, where the irrigation parameters include: a spraying angle of the irrigation sprinkler component and a progressive spraying distance of the irrigation sprinkler component.

In some embodiments, the irrigation module 1204 is further arranged for: detecting area soil moisture corresponding to the distribution location of the irrigation detection sensing component; and in response to the area soil moisture being lower than a third threshold, determining the to-be-irrigated area based on the distribution location.

In some embodiments, the irrigation module 1204 is further arranged for: determining target water source to be drawn by the water pump; and controlling the irrigation sprinkler component to direct the target water source to the to-be-irrigated area for localized irrigation based on the irrigation parameters.

In some embodiments, the irrigation module 1204 is further arranged for: in response to detecting, by the water level detection sensing component, that water level in a reservoir equipped for the target building has not dropped below a first threshold, determining water stored in the reservoir as the target water source.

In some embodiments, the irrigation module 1204 is further arranged for: in response to detecting, by the water level detection sensing component, that the water level in the reservoir has dropped below the first threshold and groundwater level has not dropped below a second threshold, determining groundwater as the target water source.

In some embodiments, the irrigation module 1204 is further arranged for: in response to detecting, by the water level detection sensing component, that the water level in the reservoir has dropped below the first threshold, the groundwater level has dropped below the second threshold, and tap water supply exists, determining tap water as the target water source.

In some embodiments, the irrigation module 1204 is further arranged for: continuously detecting through the irrigation detection sensing component whether the area soil moisture remains lower than the third threshold; and in response to the area soil moisture no longer being lower than the third threshold, shutting down the irrigation sprinkler component.

In some embodiments, the fire extinguishing and irrigation control apparatus further includes: a calibration module 1205, arranged for performing zero-point calibration on multiple components contained in the fire extinguishing and irrigation control system, where the multiple components include: an image acquisition component, a fire extinguishing sprinkler component, and an irrigation sprinkler component.

It should be noted that each of the modules can be implemented through software or hardware. For the latter, it can be achieved in the following manner, but not limited to: all modules are located within a single processor; or each module is located within different processors in any combination.

According to another aspect of embodiments of the present disclosure, a fire extinguishing and irrigation control system is further provided, including: a memory, arranged for storing an executable program; a processor, arranged for running the executable program to execute the following steps: acquiring environmental data of a target building in real time, where the environmental data is used for recording changes in surrounding environment of the target building; conducting a fire risk analysis on the environmental data to obtain an analysis result, where the analysis result is used for determining whether there is a fire risk in the surrounding environment of the target building; in response to determining, based on the analysis result, that there is the fire risk in the surrounding environment of the target building, extinguishing fire in a fire-prone area of the target building; and in response to determining, based on the analysis result, that there is no fire risk in the surrounding environment of the target building, irrigating a vegetation area of the target building according to system settings of the fire extinguishing and irrigation control system.

According to another aspect of embodiments of the present disclosure, a non-transitory storage medium is further provided. The non-transitory storage medium is arranged for storing an executable program, and when running the executable program, a device where the non-transitory storage medium is located is controlled to execute the following steps: acquiring environmental data of a target building in real time, where the environmental data is used for recording changes in surrounding environment of the target building; conducting a fire risk analysis on the environmental data to obtain an analysis result, where the analysis result is used for determining whether there is a fire risk in the surrounding environment of the target building; in response to determining, based on the analysis result, that there is the fire risk in the surrounding environment of the target building, extinguishing fire in a fire-prone area of the target building; and in response to determining, based on the analysis result, that there is no fire risk in the surrounding environment of the target building, irrigating a vegetation area of the target building according to system settings of the fire extinguishing and irrigation control system.

In the embodiments of the present disclosure mentioned above, descriptions of various embodiments each have their own focus. Parts not detailed in some embodiments can be referred to related descriptions in other embodiments.

Among the several embodiments provided in the present disclosure, it should be understood that the disclosed technical content can be implemented in other ways. Among these, the apparatus embodiments described above are illustrative. For example, division of units can be based on logical function division, and in actual implementation, there can be other division methods. For instance, multiple units or components can be combined or integrated into another system, or some features can be ignored or not executed. Another point is that mutual coupling or direct coupling or communication connections shown or discussed can be through some interfaces, indirect coupling or communication connections of units or modules, which can be electrical or in other forms.

Units described as separate components may or may not be physically separated, and components displayed as units may or may not be physical units. In other words, the components can be located in one place, or distributed across multiple units. According to actual needs, part or all of these units can be selected to achieve the purpose of the solution in some embodiments.

Additionally, functional units in various embodiments of the present disclosure can be integrated into a single processing unit, or each unit can exist alone physically, or two or more units can be integrated into a single unit. These integrated units can be implemented in the form of hardware, or in the form of software functional units.

When the integrated units are implemented in the form of software functional units and sold or used as independent products, the integrated units can be stored in a computer-readable storage medium. Based on this understanding, the technical solution of the present disclosure essentially, or the part contributing to existing technology, or parts of or the entire technical solution can be embodied in the form of a software product, which is stored in a storage medium, including instructions for enabling a computer device (which can be a personal computer, server, or network equipment, etc.) to execute all or part of the steps of the methods described in various embodiments of the present disclosure. The storage medium includes: USB drives, read-only memory (ROM), random access memory (RAM), portable hard disks, magnetic disks, or optical discs, and various other media that can store program codes.

The above description is exemplary embodiments of the present disclosure. It should be pointed out that for a person having ordinary skill in the art, without departing from the principles of the present disclosure, several improvements and modifications can further be made, and these improvements and modifications should also fall within the protection scope of the present disclosure.

1. A fire extinguishing and irrigation control method, wherein the fire extinguishing and irrigation control method is applied to a fire extinguishing and irrigation control system, and the fire extinguishing and irrigation control method comprises:
acquiring environmental data of a target building in real time, wherein the environmental data is used for recording changes in surrounding environment of the target building;
conducting a fire risk analysis on the environmental data to obtain an analysis result, wherein the analysis result is used for determining whether there is a fire risk in the surrounding environment of the target building;
in response to determining, based on the analysis result, that there is the fire risk in the surrounding environment of the target building, extinguishing fire in a fire-prone area of the target building; and
in response to determining, based on the analysis result, that there is no fire risk in the surrounding environment of the target building, irrigating a vegetation area of the target building according to system settings of the fire extinguishing and irrigation control system.

2. The fire extinguishing and irrigation control method according to claim 1, wherein the fire extinguishing and irrigation control system comprises: an image acquisition component and a disaster situation detection sensing component, wherein acquiring the environmental data of the target building in real time comprises:
performing, through the image acquisition component, image recognition on the changes in the surrounding environment of the target building to obtain image data, and sensing, through the disaster situation detection sensing component, the changes in the surrounding environment of the target building to obtain sensing data; and
determining the environmental data based on the image data and the sensing data.

3. The fire extinguishing and irrigation control method according to claim 2, wherein the fire extinguishing and irrigation control system further comprises: a fire extinguishing sprinkler component, wherein in response to determining, based on the analysis result, that there is the fire risk in the surrounding environment of the target building, extinguishing the fire in the fire-prone area of the target building comprises:
in response to determining, based on the analysis result, that there is the fire risk in the surrounding environment of the target building, determining the fire-prone area of the target building and fire extinguishing parameters of the fire extinguishing sprinkler component based on a distribution location of the disaster situation detection sensing component, wherein the fire extinguishing parameters comprise: a spraying angle of the fire extinguishing sprinkler component, and a progressive spraying distance of the fire extinguishing sprinkler component; and
controlling the fire extinguishing sprinkler component to extinguish the fire in the fire-prone area of the target building based on the fire extinguishing parameters.

4. The fire extinguishing and irrigation control method according to claim 3, wherein the fire extinguishing and irrigation control system further comprises: a water pump, controlling the fire extinguishing sprinkler component to extinguish the fire in the fire-prone area of the target building based on the fire extinguishing parameters comprises:
determining target water source to be drawn by the water pump; and
controlling, based on the fire extinguishing parameters, the fire extinguishing sprinkler component to direct the target water source to the fire-prone area of the target building for fire extinguishing.

5. The fire extinguishing and irrigation control method according to claim 4, wherein the fire extinguishing and irrigation control system further comprises: a water level detection sensing component, determining the target water source to be drawn by the water pump comprises:
in response to detecting, by the water level detection sensing component, that water level in a reservoir equipped for the target building has not dropped below a first threshold, determining water stored in the reservoir as the target water source.

6. The fire extinguishing and irrigation control method according to claim 5, wherein determining the target water source to be drawn by the water pump further comprises:
in response to detecting, by the water level detection sensing component, that the water level in the reservoir has dropped below the first threshold and groundwater level has not dropped below a second threshold, determining groundwater as the target water source.

7. The fire extinguishing and irrigation control method according to claim 6, wherein determining the target water source to be drawn by the water pump further comprises:
in response to detecting, by the water level detection sensing component, that the water level in the reservoir has dropped below the first threshold, the groundwater level has dropped below the second threshold, and tap water supply exists, determining tap water as the target water source.

8. The fire extinguishing and irrigation control method according to claim 3, wherein the fire extinguishing and irrigation control method further comprises:
continuously detecting, through the disaster situation detection sensing component, whether the fire risk still exists in the fire-prone area; and
in response to the fire risk no longer existing in the fire-prone area, shutting down the fire extinguishing sprinkler component.

9. The fire extinguishing and irrigation control method according to claim 2, wherein the fire extinguishing and irrigation control system further comprises: an irrigation sprinkler component, the system settings comprise: a start time point of periodic irrigation, an end time point of periodic irrigation, and a preset irrigation trajectory, in response to determining, based on the analysis result, that there is no fire risk in the surrounding environment of the target building, irrigating the vegetation area of the target building according to the system settings of the fire extinguishing and irrigation control system comprises:
in response to determining, based on the analysis result, that there is no fire risk in the surrounding environment of the target building and a current time point has reached the start time point, controlling the irrigation sprinkler component to conduct comprehensive irrigation over the vegetation area of the target building based on the preset irrigation trajectory.

10. The fire extinguishing and irrigation control method according to claim 9, wherein the fire extinguishing and irrigation control method further comprises:
continuously detecting whether a changed current time point has reached the end time point; and
in response to the changed current time reaching the end time point, shutting down the irrigation sprinkler component.

11. The fire extinguishing and irrigation control method according to claim 9, wherein the fire extinguishing and irrigation control system further comprises: an irrigation detection sensing component, the system settings further comprise: irrigation parameters of the irrigation sprinkler component, in response to determining, based on the analysis result, that there is no fire risk in the surrounding environment of the target building, irrigating the vegetation area of the target building according to the system settings of the fire extinguishing and irrigation control system comprises:
in response to determining, based on the analysis result, that there is no fire risk in the surrounding environment of the target building, determining a to-be-irrigated area within the vegetation area based on a distribution location of the irrigation detection sensing component; and
controlling the irrigation sprinkler component to conduct localized irrigation over the to-be-irrigated area based on the irrigation parameters, wherein the irrigation parameters comprise: a spraying angle of the irrigation sprinkler component and a progressive spraying distance of the irrigation sprinkler component.

12. The fire extinguishing and irrigation control method according to claim 11, wherein determining the to-be-irrigated area within the vegetation area based on the distribution location of the irrigation detection sensing component comprises:
detecting area soil moisture corresponding to the distribution location of the irrigation detection sensing component; and
in response to the area soil moisture being lower than a third threshold, determining the to-be-irrigated area based on the distribution location.

13. The fire extinguishing and irrigation control method according to claim 11, wherein controlling the irrigation sprinkler component to conduct localized irrigation over the to-be-irrigated areas based on the irrigation parameters comprises:
determining target water source to be drawn by the water pump; and
controlling the irrigation sprinkler component to direct the target water source to the to-be-irrigated area for localized irrigation based on the irrigation parameters.

14. The fire extinguishing and irrigation control method according to claim 13, wherein determining the target water source to be drawn by the water pump comprises:
in response to detecting, by the water level detection sensing component, that water level in a reservoir equipped for the target building has not dropped below a first threshold, determining water stored in the reservoir as the target water source.

15. The fire extinguishing and irrigation control method according to claim 14, wherein determining the target water source to be drawn by the water pump further comprises:
in response to detecting, by the water level detection sensing component, that the water level in the reservoir has dropped below the first threshold and groundwater level has not dropped below a second threshold, determining groundwater as the target water source.

16. The fire extinguishing and irrigation control method according to claim 15, wherein determining the target water source to be drawn by the water pump further comprises:
in response to detecting, by the water level detection sensing component, that the water level in the reservoir has dropped below the first threshold, the groundwater level has dropped below the second threshold, and tap water supply exists, determining tap water as the target water source.

17. The fire extinguishing and irrigation control method according to claim 12, wherein the fire extinguishing and irrigation control method further comprises:
continuously detecting through the irrigation detection sensing component whether the area soil moisture remains lower than the third threshold; and
in response to the area soil moisture no longer being lower than the third threshold, shutting down the irrigation sprinkler component.

18. The fire extinguishing and irrigation control method according to claim 1, wherein the fire extinguishing and irrigation control method further comprises:
performing zero-point calibration on multiple components contained in the fire extinguishing and irrigation control system, wherein the multiple components comprise:
an image acquisition component, a fire extinguishing sprinkler component, and an irrigation sprinkler component.

19. A fire extinguishing and irrigation control system, comprising:
a memory, arranged for storing an executable program;
a processor, arranged for running the executable program to execute the following steps:
acquiring environmental data of a target building in real time, wherein the environmental data is used for recording changes in surrounding environment of the target building;
conducting a fire risk analysis on the environmental data to obtain an analysis result, wherein the analysis result is used for determining whether there is a fire risk in the surrounding environment of the target building;
in response to determining, based on the analysis result, that there is the fire risk in the surrounding environment of the target building, extinguishing fire in a fire-prone area of the target building; and
in response to determining, based on the analysis result, that there is no fire risk in the surrounding environment of the target building, irrigating a vegetation area of the target building according to system settings of the fire extinguishing and irrigation control system.

20. A non-transitory storage medium, wherein the non-transitory storage medium is arranged for storing an executable program, and when running the executable program, a device where the non-transitory storage medium is located is controlled to execute the following steps:
acquiring environmental data of a target building in real time, wherein the environmental data is used for recording changes in surrounding environment of the target building;
conducting a fire risk analysis on the environmental data to obtain an analysis result, wherein the analysis result is used for determining whether there is a fire risk in the surrounding environment of the target building;
in response to determining, based on the analysis result, that there is the fire risk in the surrounding environment of the target building, extinguishing fire in a fire-prone area of the target building; and
in response to determining, based on the analysis result, that there is no fire risk in the surrounding environment of the target building, irrigating a vegetation area of the target building according to system settings of the fire extinguishing and irrigation control system.
